(19) United States
(12) Patent Application Publication
(10) Pub. No.: US 2026/0302298 A1
(43) Pub. Date: Oct. 1, 2026

(54) HIGH-PERFORMANCE, DURABLE, AND SELF-REGENERATING ZINC-BASED FLOW BATTERY

(71) Applicant: City University of Hong Kong, Hong Kong (HK)

(72) Inventors: Chunyi ZHI, Hong Kong (HK); Shengnan WANG, Hong Kong (HK)

(21) Appl. No.: 19/093,192

(22) Filed: Mar. 27, 2025

(51) Int. Cl. H01M 8/06; H01M 4/86; H01M 8/04186; H01M 8/18

(52) U.S. Cl. CPC H01M 8/0693; H01M 4/86; H01M 8/04186; H01M 8/188

(57) ABSTRACT

The present invention provides a strategy to address issues in zinc-based batteries using Zn—Bi₂O₃ chemistry. Electrochemical oxidation of dead zinc by Bi₂O₃ effectively restores the battery's lost capacity. Additionally, saturated high-valent bismuth salts in the anolyte help form functional Bi and ZnBi alloy interfaces, reducing zinc dendrite growth. Alkaline zinc-iron flow batteries (AZIFBs) with Bi₂O₃ can maintain an AUR of 99% at 160 mA cm⁻², the highest reported for ZFBs at this current density. These AZIFBs also offer exceptional cycling stability, over 800 hours, with an average coulombic efficiency (CE) of 99.6% and an areal capacity of 99.5 mAh cm⁻². This research provides insights into the development of high-energy-density, low-cost ZFBs with excellent AUR.

### FIELD OF THE INVENTION

The present invention generally relates to the field of materials, energy storage chemistry, functional material interfaces.

### BACKGROUND OF THE INVENTION

With the growing challenges of carbon emissions and the energy crisis, there is a critical need for efficient energy storage solutions to replace fossil fuels. A reliable and cost-effective energy storage system is essential for bridging the gap between power generation and consumption. In particular, aqueous redox flow batteries (ARFBs) have drawn considerable attention because of their safety, their long cycle life, and their decoupling of energy storage from power generation.

Among all the reported ARFBs, zinc-based flow batteries (ZFBs) are considered to be highly suitable batteries for stationary energy storage because of their abundant reserves, safety, high capacity, good environmental benignity, and high cell voltage (low electrochemical potential of the Zn redox couple, −0.763 V vs. standard hydrogen electrode in neutral media, −1.22 V vs. standard hydrogen electrode in alkaline media).

Zinc deposition plays a vital role in the performance of batteries, particularly in their coulombic efficiency (CE) and cycling stability. However, with the repeated stripping and plating of zinc anodes, dendrites commonly form due to inhomogeneous reactions. During discharge, the unevenly deposited zinc dendrites can lose contact with the electrode under the flow of electrolyte, resulting in the formation of dead zinc (FIG. 1). This accumulation of inactive zinc metal material not only causes an irreversible loss of battery capacity but also poses a risk of pipeline clogging, ultimately reducing the battery's efficiencies and cycle life. As a result of zinc exfoliation and the formation of dendrites, ZFBs typically operate at a low anolyte utilization rate (AUR) with a limited areal capacity, which severely limits their ability to provide high energy and power density.

Many studies have concentrated on developing zinc anodes through the modification of electrode surfaces, design of host structures, and optimization of electrolyte formulations.¹⁻³ However, most of these studies have been conducted at a relatively low current density and areal capacity with a low active material utilization rate, and their proposed solutions may not be suitable for the conditions in which ZFBs operate. Therefore, feasible approaches for addressing the problem of zinc exfoliation and dendrite formation and regenerating dead zinc to achieve high-performance ZFBs with a long cycle life are urgently required.

### SUMMARY OF THE INVENTION

This invention addresses these shortcomings of alkaline zinc-iron flow batteries (AZIFBs) by utilizing Zn—Bi₂O₃ chemistry to mitigate issues of dead zinc and dendrite formation, thereby enhancing cycle life at a high AUR. More specifically, Bi₂O₃ facilitates the electrochemical oxidation of zinc exfoliation in the anolyte, enabling rapid recovery of dead zinc's capacity. Additionally, saturated high-valent bismuth salts in the anolyte help form functional Bi and ZnBi alloy interfaces, reducing zinc dendrite growth.

With the regenerative capacity of dead zinc and the high reversibility of zinc anodes, an ultrastable Bi₂03-based AZIFB is developed, capable of maintaining an AUR of 99% at a current density of 80 mA cm⁻² and a high areal capacity of 99.5 mAh cm⁻². The battery delivers an average CE of 99.6% for over 800 hours, with a discharge energy of 44.8 Wh L⁻¹, effectively reducing anolyte costs to approximately $2.42/kWh.

In one aspect, the present invention provides a high-performance, durable, and self-regenerating zinc-based flow battery. The flow battery includes an anolyte containing zinc salts and an electrochemical modifier, a catholyte containing ferrocyanide salts, a membrane separating the anolyte and the catholyte, an anode containing a zinc-compatible material, a cathode containing an active material, a flow system configured to circulate the anolyte and the catholyte, and a power management system operably connected to the anode and the cathode.

In one embodiment, the electrochemical modifier facilitates an electrochemical oxidation of dead zinc formed on the anode, enhancing an anolyte utilization rate to at least 99% at an even higher areal capacity of at least 100 mAh cm⁻² for over 800 hours, and promoting uniform and dense zinc deposition during cycling.

In one embodiment, the electrochemical modifier has a concentration sufficient to sustain oxidation of the dead zinc for at least 200 cycles.

In one embodiment, the anolyte further includes Zn(OH)₄²⁻ and a supporting electrolyte selected from KOH and NaOH. The concentration of Zn(OH)₄²⁻ in the anolyte is between 0.3 and 0.5 mol L⁻¹, and the concentration of the supporting electrolyte is between 1 to 5 mol L⁻¹.

In one embodiment, when during charging, the Zn(OH)₄²⁻ undergoes reduction to deposit Zn on the anode, and the active material undergoes an oxidation reaction on the cathode. When during discharge, oxidated active material undergoes a reduction reaction, and the Zn on the anode undergoes an oxidation reaction to form the Zn(OH)₄²⁻.

In one embodiment, the active material includes one or more of Na₄Fe(CN)₆, K₄Fe(CN)₆, Na₃Fe(CN)₆, K₃Fe(CN)₆, with a concentration of 0.1 to 1.6 mol L⁻¹.

In one embodiment, the zinc salts include one or more of ZnO, Zn(CH₃COO)₂, ZnBr₂, ZnCl₂, ZnSO₄, with a concentration of 0.1 to 2 mol L⁻¹.

In one embodiment, the electrochemical modifier includes bismuth(III) oxide, indium oxide (In₂O₃), or a combination thereof.

In one embodiment, the catholyte further includes a supporting salt comprising one or more of, KOH, NaOH, with a concentration of 0.1 to 5 mol L⁻¹.

In one embodiment, the membrane includes a porous membrane or an ion exchange membrane.

In one embodiment, the zinc-compatible material includes carbon felt or a zinc plate.

In another embodiment, the zinc-based flow battery further includes a graphite plate configured to support the anode and cathode structures.

In one embodiment, the electrochemical oxidation of the dead zinc allows for recovery of at least 90% of exfoliated dead zinc.

In one embodiment, the zinc-based flow battery is configured to operate at a current density of 80 mA cm⁻² and achieves an anolyte utilization rate of at least 99%, delivering an average coulombic efficiency of at least 99% over more than 450 cycles.

In one embodiment, the zinc-based flow battery maintains an average energy efficiency of at least 85% over 300 cycles.

In one embodiment, a functional interface comprising bismuth and ZnBi alloy is formed during cycling.

In another aspect, the present invention provides a method for reducing zinc dendrite growth and dead zinc accumulation in a zinc-based flow battery, including providing an anolyte containing Zn(OH)₄²⁻ at a concentration of 0.3 to 0.5 mol L⁻¹ and an electrochemical modifier, operating the zinc-based flow battery by cycling between charging and discharging states, oxidizing dead zinc in the anolyte via electrochemical oxidation facilitated by the electrochemical modifier to regenerate active zinc species, and forming a functional interface comprising bismuth and ZnBi alloy interface to regulate zinc deposition and suppress dendrite growth. The zinc-based flow battery is operated at a current density of at least 80 mA cm⁻², and the zinc-based flow battery achieves an areal capacity of at least 100 mAh cm⁻² while maintaining an anolyte utilization rate of at least 99% for over 800 hours.

In another embodiment, the method further involves stirring the electrochemical modifier in the anolyte to ensure contact with exfoliated dead zinc.

In one embodiment, the electrochemical modifier has a concentration sufficient to sustain oxidation of the dead zinc for at least 200 cycles.

In another embodiment, the method further involves collecting and recycling metallic bismuth formed during the oxidation of dead zinc.

In one embodiment, the electrochemical modifier includes bismuth(III) oxide, indium oxide (In₂O₃), or a combination thereof.

The present invention offers significant advantages over existing technology:

1. This invention demonstrates, for the first time, that the AZIFB with Bi₂O₃ achieves approximately 100% AUR at 160 mA cm⁻², representing the highest reported value for ZFBs at such a high current density.

2. The incorporation of Bi₂O₃ into the electrolyte presents a straightforward and easily implementable approach.

3. The reduction of Bi₂O₃ to Bi metal improves electrolyte utilization to near 100%, resulting in a reduction of anolyte costs to below $2.3 per kWh for AZIFBs.

### BRIEF DESCRIPTION OF THE DRAWINGS

Embodiments of the invention are described in more details hereinafter with reference to the drawings, in which:

FIG. 1 shows a schematic of an AZIFB. The enlarged view depicts the exfoliation of zinc and the formation of dendrites;

FIG. 2 shows a schematic of regeneration of dead zinc promoted by Zn—Bi₂O₃ chemistry in AZIFBs;

FIG. 3 shows cycling performance of AZIFBs with and without Bi₂O₃ at 80 mA cm⁻²;

FIG. 4 shows XRD pattern of Bi₂O₃ before and after soaking in electrolyte for 30 days;

FIG. 5 shows galvanostatic discharge profiles at 10, 20, and 40 A g⁻¹ in a Zn//Bi₂O₃ coin battery;

FIG. 6 shows XRD pattern of the cathode of Zn//Bi₂O₃ battery after discharge;

FIG. 7A shows digital photographs of Bi₂O₃ in the electrolyte before and after adding zinc foil. FIG. 7B shows digital photographs of zinc foil before and after touching Bi₂O₃ in the electrolyte;

FIG. 8 shows ICP-MS results of Zn(OH)₄²⁻ and Bi* concentrations in an electrolyte containing excess Bi₂O₃ after adding zinc powder;

FIG. 9 shows cycling performance of Zn//CF flow cells with and without Bi₂O₃ at 80 mA cm⁻²;

FIG. 10 shows digital photographs of the anolyte at an anodic tank before and after 120 cycles at 80 mA cm⁻² under an areal capacity of 23.8 mAh cm⁻²;

FIG. 11 shows galvanostatic charging-discharging profiles at the 1st and 5th cycles of Zn//CF flow cells with and without Bi₂O₃ at 80 mA cm⁻². The inset shows corresponding detailed voltage profiles at the 1^{st} cycle of Zn//CF flow cell with and without Bi₂O₃ marked by rectangles;

FIG. 12A shows voltage profiles at the 20^{th}, 40^{th}, and 110^{th} cycles of Zn//CF flow cells with and without Bi₂O₃. FIG. 12B shows XRD pattern of taupe deposits in the anolyte tank, and corresponding elemental maps of taupe deposits in the anolyte tank. FIG. 12C shows cycling performance of Zn//CF flow cells with and without Bi₂O₃ at an areal capacity of 79.6 mAh cm⁻². FIG. 12D shows performance of the Zn//CF flow cell with Bi₂O₃ under capacity decay conditions;

FIG. 13 shows regeneration amount of dead zinc in Zn//CF flow cell with Bi₂O₃ during battery operation;

FIG. 14A shows various potential differences of Zn(OH)₄²⁻/Zn, Bi₂O₃/Bi and Fe(CN)₆⁴⁻/Fe(CN)₆³⁻ redox couples. FIG. 14B shows galvanostatic charging-discharging profiles at the 10th, 80th, and 400th cycles of an AZIFB with Bi₂O₃, and corresponding detailed voltage profiles marked by rectangles;

FIG. 15 shows SEM images and corresponding elemental maps of anodic CF charged to 1.6 V at the 75th cycle of an AZIFB with Bi₂O₃;

FIG. 16A shows XRD pattern of the anodic carbon felt charged to 1.6 V for the 75^{th} cycle of AZIFB with Bi₂O₃, and FIG. 16B shows partially magnified XRD pattern of the anodic carbon felt;

FIG. 17A shows XPS spectra of the charged anodic carbon felt taken from AZIFB with and without Bi₂O₃. FIG. 17B shows high-resolution XPS Zn 2p spectra of bare Zn and Bi@Zn anodes;

FIG. 18A shows adsorption energy of Zn atoms on Zn, C, Bi, and ZnBi substrates. FIGS. 18B-18D show difference in charge density distribution at the interface of Zn atoms on Bi, ZnBi, and C substrates;

FIG. 19 shows polarization curves of Zn deposition of AZIFBs with and without Bi₂O₃ at 100 mA cm⁻²;

FIG. 20 shows SEM images of Zn deposition after several cycles at 80 mA cm⁻² in AZIFBs with and without Bi₂O₃. Each scale bar represents 10 μm;

FIG. 21A shows XRD patterns of the Zn deposit at the 30^{th} end of charging of the AZIFBs with and without Bi₂O₃, and FIG. 21B shows XRD patterns of the Zn deposit at the 75^{th} and 120^{th} end of charging for the AZIFBs with Bi₂O₃;

FIG. 22 shows cycling performance of AZIFBs with and without Bi₂O₃ at 80 mA cm⁻²;

FIG. 23A shows voltage profiles at the 10^{th}, 80^{th}, and 100^{th} cycles of AZIFB without Bi₂O₃ at 80 mA cm⁻². FIG. 23B shows rate performance of AZIFBs with and without Bi₂O₃ at current densities ranging from 40 to 120 mA cm⁻²;

FIG. 24 shows voltage profiles of AZIFBs with and without Bi₂O₃ at current densities ranging from 40 to 120 mA cm⁻²;

FIG. 25 shows COMSOL Multiphysics simulation results of Zn(OH)₄²⁻ and Fe(CN)₆⁴⁻ distribution at the beginning of the 100^{th} cycle on the negative and positive electrodes of AZIFBs without and with Bi₂O₃;

FIG. 26 shows long-term performance of an AZIFB with Bi₂O₃ at a Zn(OH)₄²⁻ concentration of 0.5 mol L⁻¹ at 80 mA cm⁻²;

FIG. 27A shows discharge capacity, discharge energy and discharge median voltage of an AZIFB with Bi₂O₃ at a Zn(OH)₄²⁻ concentration of 0.5 mol L⁻¹ at 80 mA cm⁻². FIG. 27B shows voltage profiles at the 5^{th}, 100^{th}, and 250^{th} cycles of an AZIFB with Bi₂O₃ at a Zn(OH)₄²⁻ concentration of 0.5 mol L⁻¹. FIG. 27C shows detailed voltage profiles at the beginning of charging;

FIG. 28 shows cycling performance of AZIFBs with and without Bi₂O₃ at 160 mA cm⁻²;

FIG. 29A shows recovered amount of dead zinc in the AZIFB with Bi₂O₃ while operating at 80 mA cm⁻² and 99.5 mAh cm⁻². FIG. 29B shows long-term performance of an AZIFB without Bi₂O₃ at a Zn(OH)₄²⁻ concentration of 0.5 mol L⁻¹ at 80 mA cm⁻². FIG. 29C shows comparison of anolyte cost and energy density in different AZIFBs. FIG. 29D shows a comparison of battery performance in terms of electrolyte utilization rate, current density, cycle life, CE, and voltage with zinc-iron (Zn—Fe), zinc-manganese (Zn—Mn), zinc-bromine (Zn—Br), Zinc-Ferrocene (Zn-Fc), and zinc-iodine (Zn—I) flow batteries; and

FIG. 30 shows a schematic diagram of a storage tank with stirring and Bi₂O₃ addition functions.

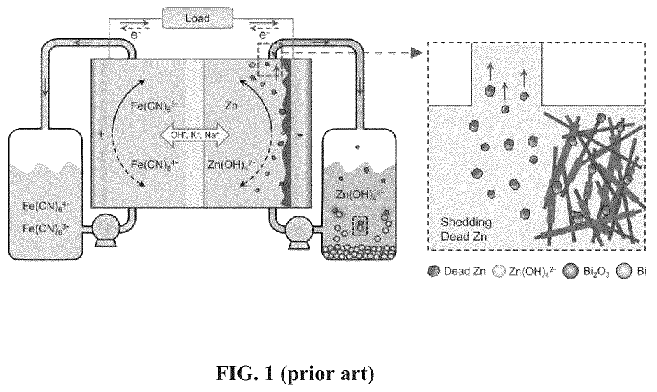

### DETAILED DESCRIPTION

In the following description, detailed formulations of the anolyte and catholyte compositions, configurations of the flow battery system, and methodologies for incorporating Bi₂O₃ to facilitate the electrochemical oxidation of dead zinc are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Zinc-based flow batteries (ZFBs) are regarded as promising candidates for large-scale energy storage systems. However, the formation of dead zinc and dendrites, especially at high areal capacities and current densities, makes ZFBs commonly operate at a low AUR, limiting their applications.

Recently, bismuth oxide (Bi₂O₃) has been studied as an electrode material for static rechargeable alkaline batteries, offering advantages such as low redox potential, high theoretical capacitance, low cost, and environmental friendliness. Typically, Bi₂O₃ undergoes a quasi-conversion reaction of charge storage (Bi₂O₃↔Bi⁰), which makes it suitable for use at a high current density.

Inspired by this mechanism, this invention aims to provide a physical method to address the issue of Zn exfoliation/dendrite, and further enhance the cycle life of AZIFB at a high AUR. Specifically, the present invention provides a zinc-based flow battery that incorporates Bi₂O₃ to enhance anolyte utilization, improve zinc deposition uniformity, suppress dendrite formation, and extend battery cycle life. Unlike conventional zinc-based flow batteries (ZFBs), which suffer from performance degradation due to dead zinc accumulation and uneven zinc deposition, the disclosed battery system effectively regenerates inactive zinc while maintaining high CE and energy efficiency (EE) over extended cycles.

The present invention also relates to optimizing electrode interfaces, electrolyte compositions, and operational conditions to achieve high CE, stable cycling performance, and enhanced energy density, making the technology suitable for large-scale energy storage applications.

The anolyte may include zinc salts and Bi₂O₃, facilitating the oxidation of detached or inactive zinc particles (dead zinc), thereby reintroducing them into the electrochemical cycle.

The catholyte may include ferrocyanide salts, specifically Na₄Fe(CN)₆ or K₄Fe(CN)₆, maintained at a concentration of 0.1-1.6 mol L⁻¹. This choice ensures high redox stability and minimizes side reactions that could compromise cycle life.

The membrane separating the anolyte and catholyte may include polybenzimidazole (PBI) membrane, Nafion membrane, and porous polyolefin membrane. For example, the PBI membrane is selected for its superior chemical stability and ionic selectivity, which reduces cross-contamination and enhances battery longevity.

The anode may include carbon felt or a zinc plate, which provides a high surface area of at least 20 mAh cm⁻² for uniform zinc deposition. The cathode, made of an active material, supports ferrocyanide redox reactions.

The presence of Zn(OH)₄²⁻, maintained within a concentration range of 0.1 to 2 mol L⁻¹, ensures a steady zinc-ion supply and prevents localized depletion during operation. The supporting electrolyte, selected from KOH or NaOH, optimizes ion conductivity and stabilizes zinc complexation.

In one embodiment, during charging, the Zn(OH)₄²⁻ undergoes reduction to deposit Zn on the anode, while Fe(CN)₆⁴⁻ undergoes oxidation to form Fe(CN)₆³⁻ at the cathode. Conversely, during discharge, Zn is oxidized back to Zn(OH)₄²⁻, and Fe(CN)₆³⁻ undergoes reduction to regenerate Fe(CN)₆⁴⁻, completing the cycle.

The disclosed battery system is adaptable for single-cell or multi-cell stack configurations, enabling scale-up for high-power applications. By adjusting the electrolyte flow rate and electrode surface area, the battery can be optimized for diverse energy storage needs.

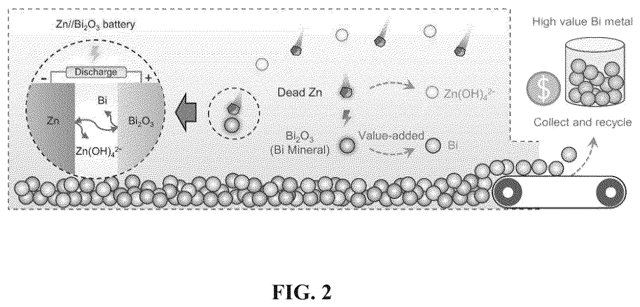

Moreover, the invention also relates to methods for improving zinc-based flow battery performance and regenerating dead zinc through Bi₂O₃-mediated electrochemical oxidation. The present invention utilizes this reaction as a conceptual foundation to develop a Zn//Bi₂O₃ battery composed of electrochemically coupled Bi₂O₃ and dead zinc. This system may spontaneously undergo a discharge reaction, fully converting the exfoliated zinc into Zn(OH)₄²⁻, which then returns to the anolyte, effectively restoring the concentration of Zn(OH)₄²⁻ (FIG. 2).

The formation of “dead Zn” and dendrites, which lead to irreversible capacity loss and reduced cycle life, especially at high areal capacity and current density, causes ZFBs to generally operate at a low AUR. This limitation hinders their ability to achieve high energy density and power densities. The invention presents an effective strategy for addressing the issues of dead Zn and dendrites by adding Bi₂O₃ into the anolyte tank. Bi₂O₃ is the main constituent of bismuth minerals, and bismuth is typically produced through the reduction of Bi₂O₃. Bi₂O₃ can be in-situ assembled with exfoliated Zn into primary batteries. The oxidation of dead zinc generates metallic bismuth, which can be collected and recycled, contributing to cost efficiency and sustainability.

Moreover, saturated high-valent bismuth salts in the anolyte will form a functional Bi and ZnBi alloy interface. The Bi/ZnBi alloy interfaces formed in situ not only regulate zinc ion transport and deposition but also significantly reduce zinc dendrite growth, thereby mitigating short circuits and capacity fading. The high-valent bismuth salts in the anolyte further enhances zinc oxidation kinetics, promoting the rapid dissolution of dead zinc. This mechanism extends the operational lifespan of the battery and improves anolyte utilization rates, sustaining efficiencies over prolonged cycling.

Benefiting from the Bi₂O₃-mediated dead Zn oxidation process, which recovers the capacity of lost dead Zn, and the in-situ formed functional interface of Bi and ZnBi alloy that induce uniform and dense Zn deposition, the cycling performance of Zn anode under high current density, high areal capacity and deep-cycle conditions is significantly improved.

As a result, the AZIFB with Bi₂O₃ can maintain approximately 100% AUR at 160 mA cm⁻², which is the highest value ever reported for ZFBs operating at such a high current density. The AZIFB with Bi₂O₃ can also deliver an ultra-stable cycling stability over 800 hours with an average CE of 99.6% at high areal capacity of at least 99 mAh cm⁻². This enables competitive energy density and cost-effective ZFBs with high AUR, fostering their further development.

### EXAMPLE

### Example 1—Materials and Methods

Zinc oxide, potassium hydroxide, sodium hydroxide and sodium Hexacyanoferrate (II) are purchased from Aladdin (China). Bismuth oxide (Bi₂O₃) is purchased from Xindun-Alloy Co., Ltd. (China). Carbon felt (CF) is purchased from Liaoyang J-Carbon Materials Co., Ltd. (China) and used as received. All electrolytes are prepared with deionized water.

The microstructure and elemental distribution of Zn, Bi and Bi₂O₃ deposits are characterized by field emission scanning electron microscope (SEM, JEOL-7001F) equipped with an energy-dispersive X-ray spectroscopy (EDS). The X-ray diffraction (XRD) patterns of deposits are tested using an X-ray diffractometer (Rigaku SmartLab 9 kW). X-ray photoelectron spectroscopy (XPS) spectra are collected on the Thermo Scientific K-Alpha equipment. The contents of Zn and Bi elements in the electrolyte are analyzed by inductively coupled plasma mass spectrometry (Agilent 720ES).

### Ab-Initio Calculations

The absorption energy (Eₐ) is carried out by Vienna Ab-initio Simulation Package (VASP), within the framework of density functional theory (DFT). Electronic exchange and correlation energies are treated at the level of generalized gradient approximation (GGA) with the Perdew, Burke, and Ernzerhof (PBE) functional. The core electrons are treated with the projector-augmented wave (PAW) method. Vander Waals interaction is taken into account at DFT-D3 with Becke-Jonson (BJ) damping level. The plane wave cutoff is set to 500 eV. A 15 Å-width vacuum is added along the vertical direction normal to the surfaces. The Brillouin zone integration is carried out with 3×3×1 Gamma point. The convergence thresholds for energy are set as 10⁻⁵ eV during ion relaxation, and the convergence thresholds for force are set as 0.02 eV Å⁻¹. The absorption energy can be obtained by the following equation:

$${E}_{a} = {E}_{Zn - substrate} - {E}_{Zn} - {E}_{substrate} ,$$

where E_{Zn-substrate}, E_{zn}, and E_{substrate} represent the energies of the Zn adsorbed metal surface, Zn atom, and the clean metal surface, respectively.

### Comsol Multiphysics Simulation

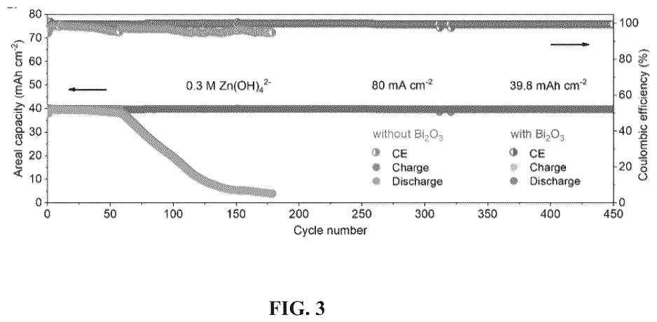

A two-dimensional stationary model is constructed to simulate the ion distribution for AZIFBs with and without Bi₂O₃. The model is built by employing Darcy's Law and the tertiary current distribution physical field and solved by the commercial package COMSOL Multiphysics®. The simulation considers the coupling effect of electric, concentration, and velocity fields. The computational domain includes positive and anodes and membranes. The area of the electrode is 2×2 cm⁻², the thickness is 5 mm, and the membrane thickness is 900 μm. The positive and anodes are both porous CF with a porosity of 90%. The electrode boundary condition is set to velocity inlet, and the inflow velocity in the normal direction is set to 2 mm/s. The electrode outlet boundary condition is set to pressure outlet and set to atmospheric pressure. The diffusion coefficient of different ions is shown in Table 1. The solver is PARDISO, and the relative error tolerance is set to 0.001. The simulation employs the galvanostatic method with a current density of 80 mA cm⁻², which is consistent with the experimental conditions. The Zn(OH)₄²⁻ ion concentrations at the beginning of the 100^{th} charge are calculated to be 0.3 mol L⁻¹ and 0.147 mol L⁻¹ for the batteries with and without Bi₂O₃, respectively, based on the charge capacity values in FIG. 3. The initial concentrations of Fe(CN)₆⁴⁻ in AZIFBs are all 0.6 mol L⁻¹. The electronic conductivity is 0.8×10⁶ S/m and 1.5×10³ S/m for the cases with and without Bi₂O₃, respectively.

TABLE 1
The diffusion coefficient of different ions

| Ions | Value (cm²/s) |
|---|---|
| Zn(OH)₄²⁻ | 1.2 × 10⁻⁶ |
| OH⁻ | 5.3 × 10⁻⁵ |
| K⁺ | 1.9 × 10⁻⁵ |
| Fe(CN)₆⁴⁻ | 7.8 × 10⁻⁶ |
| Fe(CN)₆³⁻ | 8.2 × 10⁻⁶ |

### Example 2—Preparation of Zn//Bi₂O₃ Coin Battery and Zn//CF Flow Cell

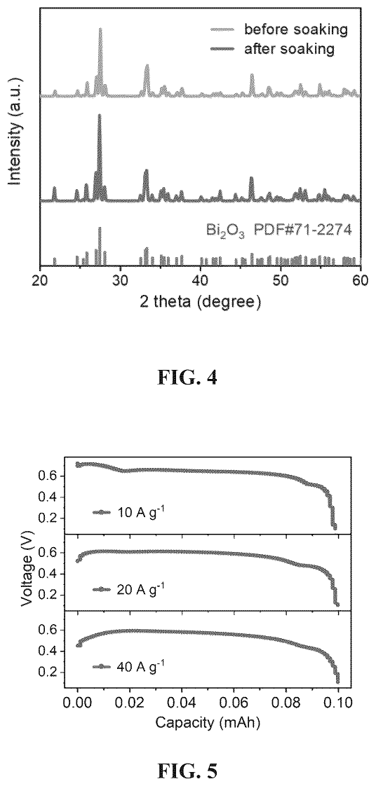

In this example, the chemical behavior of Bi₂O₃ is investigated under alkaline conditions. After 30 days of immersion, the Bi₂O₃ at the bottom of the bottle remains light yellow, and the upper electrolyte remains clear. No change is observed in the X-ray diffraction (XRD) patterns of Bi₂O₃ before and after immersion in the electrolyte, indicating its excellent chemical stability in the alkaline electrolyte used in AZIFB (FIG. 4).

For the cathode, Bi₂O₃ powder, active carbon and PVDF binder are mixed in N-Methyl-2-pyrrolidone (NMP) solvent with a mass ratio of 8:1:1. The mixture is grounded in a mortar for at least 30 mins to form a paste and then coated the paste onto a piece of carbon cloth paper. The cathode electrode is finally obtained after drying at 60° C. The effective mass loading of the Bi₂O₃ cathode is consistent. Zn//Bi₂O₃ batteries are assembled in CR2032-type coin cells in an air atmosphere, around 75 L electrolyte, using zinc foil (50 μm) as anode and glass fiber filter (Whatman, GF/C) as the separator. The battery performance is performed by a LAND battery charge/discharge system of CT3001A series (China).

Similar to full battery assembling, the zinc//carbon felt (Zn//CF) flow cell is assembled by using Zn plate (2 cm×2 cm×0.05 cm) attached CF (2 cm×2 cm×0.42 cm) as cathode, CF (2 cm×2 cm×0.5 cm) as anode. The electrolytes flowing past the positive and anodes of the battery are identical, containing 0.3 mol L⁻¹ Zn(OH)₄²⁻ and 3.2 mol L⁻¹ OH⁻. And the PBI membrane is used to separate the catholyte and anolyte. The test is carried out by plating a given amount of Zn metal onto the CF substrate, followed by stripping Zn metal from the CF substrate with a cut-off voltage.

The reaction kinetics of the Zn—Bi₂O₃ chemistry are studied by assembling a Zn//Bi₂O₃ coin battery. The following is the reaction on the cathode during the discharge process:

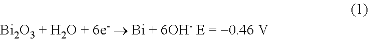

The following is the reaction on the anode during the charge process:

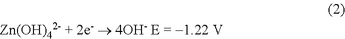

FIG. 5 depicts the discharge curves of the battery at current rates ranging from 10 to 40 Ag⁻¹. At a high current density of 40 Ag⁻¹, the Zn//Bi₂O₃ coin battery retains 98.1% of its capacity at 10 Ag⁻¹, demonstrating its excellent rate capability and rapid dead zinc regeneration.

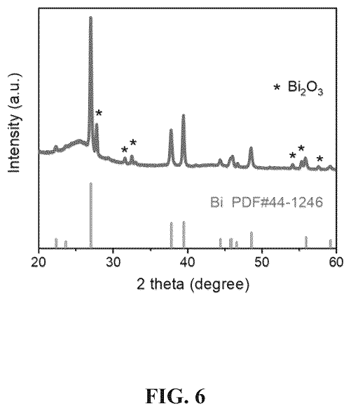

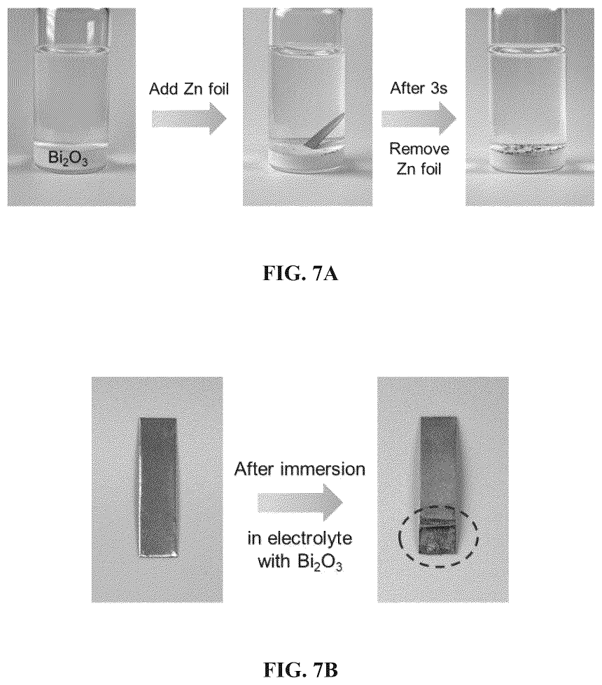

As shown in FIG. 6, XRD analysis of the cathode after discharge confirms the formation of metallic bismuth. In the visualized battery, once the zinc strip comes into contact with Bi₂O₃, taupe bismuth immediately appeared, and the zinc strip starts corroding, indicating the rapid electrochemical kinetics of dead zinc oxidation (FIGS. 7A-7B).

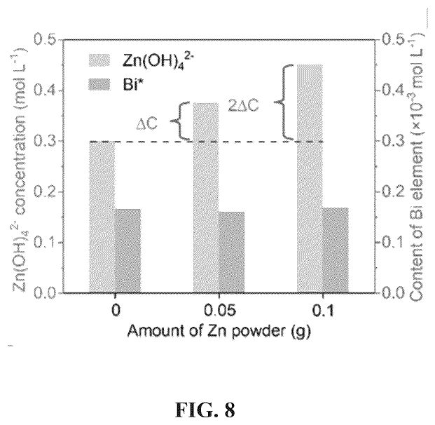

FIG. 8 shows the inductively coupled plasma mass spectrometry (ICP-MS) results of Zn(OH)₄²⁻ concentration in an electrolyte containing sufficient Bi₂O₃ after adding zinc powder. When the amount of zinc powder is increased from 0.05 to 0.1 g, the change of Zn(OH)₄²⁻ concentration doubles, indicating the complete redox of the added zinc powder. In addition, trace amounts of high-valent bismuth salts (primarily BiO₂, hereinafter referred to as Bi*) are observed in the electrolyte. The concentrations of Bi* in the three aforementioned solutions are 1.65×10⁻⁴, 1.60 ×10⁻⁴, and 1.68×10⁻⁴ mol L⁻¹. These findings confirm the saturation of Bi* in the electrolyte with excess Bi₂O₃.

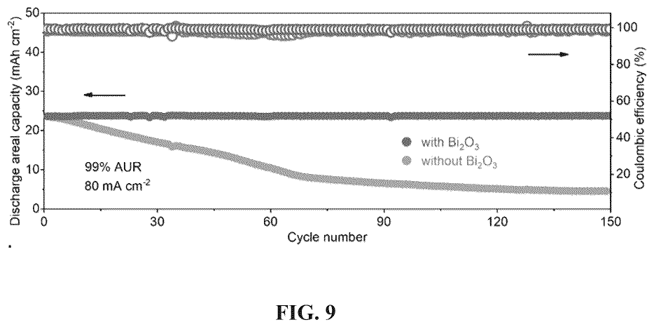

Furthermore, the Zn//CF flow cells are used to examine the role and performance of Bi₂O₃ in scale-up flow batteries. FIG. 9 demonstrates the cycling stability of flow cells with and without Bi₂O₃ at a current density of 80 mA cm 2 and an AUR of 99% (considering side reactions, charged to 99% of the theoretical capacity of Zn(OH)₄²⁻ or a protecting cutoff voltage, fully discharged to a cutoff voltage). After the cell without Bi₂O₃ stably runs for a few cycles, the discharge capacity gradually falls below 5 mAh cm⁻² at a capacity fading rate of approximately 0.13 mAh cm⁻² per cycle.

During the 1^{st} and 120^{th} charge cycles, the Zn//CF flow cell operates without Bi₂O₃, with anolyte and catholyte utilization rates of 99% and around 50%, respectively. Unevenly deposited zinc dendrites may detach from the electrode, forming dead zinc. As detached zinc falls off the CF electrode, it flows with the electrolyte into the storage tank. Given that zinc (7.14 g·cm⁻³) is significantly denser than the electrolyte (about 1.16 g·cm⁻³ for 0.3 mol L⁻¹ Zn(OH)₄²⁻ and 3.2 mol L⁻¹ OH⁻), the dead zinc settles at the bottom of the tank, permanently losing contact with the electrode.

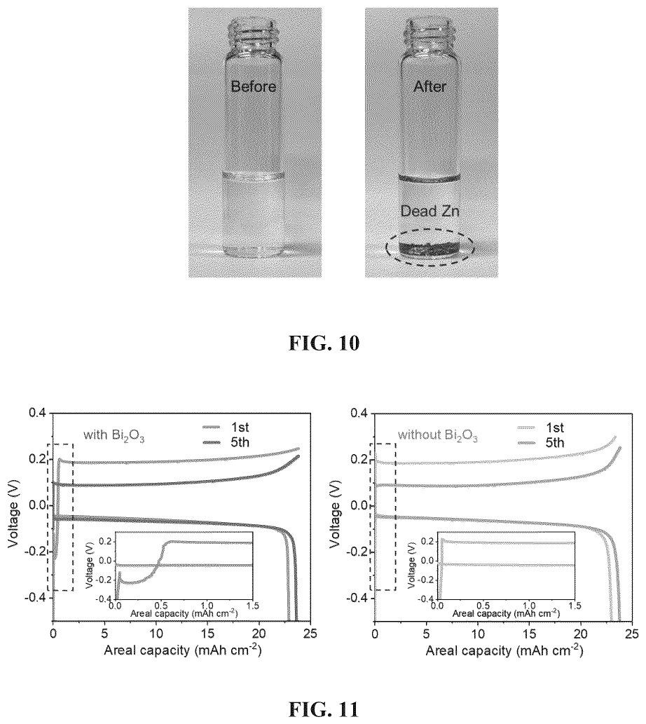

Referring to FIG. 10, the noticeable silver-grey zinc particles are observed in the external tank with electrolyte circulation, depicting the degradation process of zinc anodes. The exfoliated dead zinc accumulated at the bottom of the tank cannot circulate with the electrolyte, thereby completely losing the opportunity to contact the electrode. Simultaneously, the values of CE fluctuate throughout the plating and stripping cycles due to the large amount of dead zinc.

By contrast, with Bi₂O₃ in the anolyte, the Zn//CF flow cell undergoes 150 cycles without a reduction in capacity, maintaining a high average CE of 99.1% and an areal capacity of 23.8 mAh cm⁻².

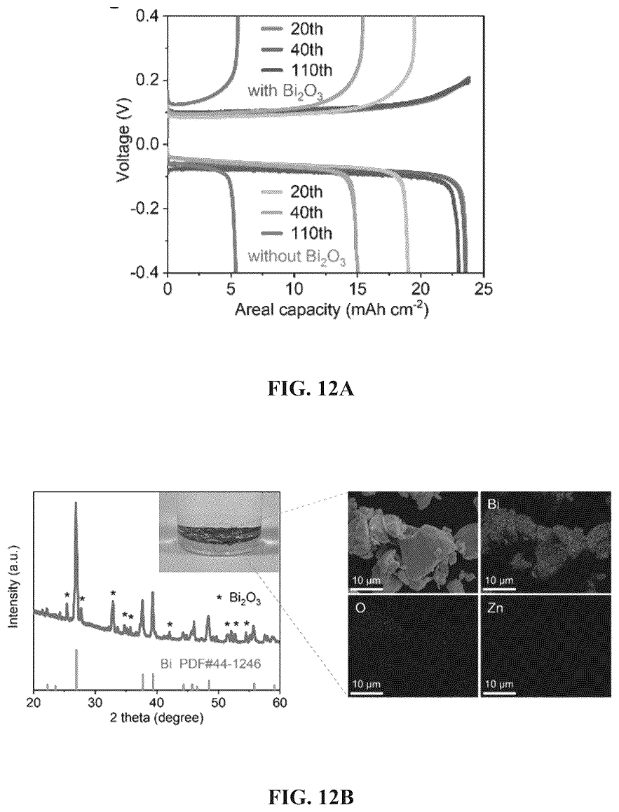

As shown in FIG. 11, the charging curves of the Zn//CF flow cell without Bi₂O₃ do not exhibit a sharp surge at the end of the early stage of cycling. However, at the end of the charge, the curve for the 5^{th} cycle shows a more pronounced upward trend compared to the 1^{st} cycle. These results indicate that as the cycles progress, the capacity loss caused by dead zinc rapidly exacerbates its impact on battery performance.

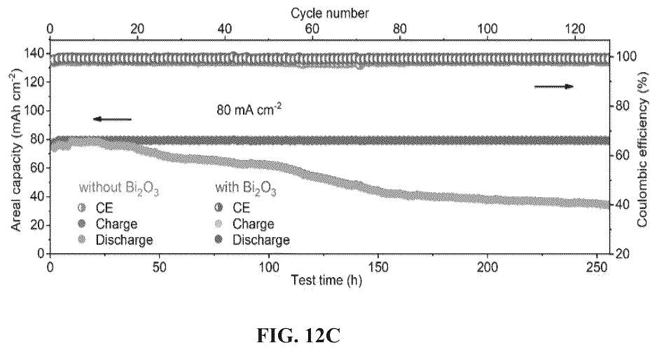

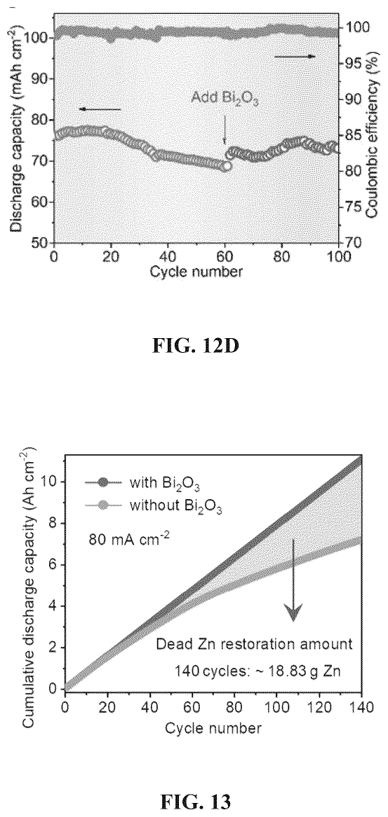

FIG. 12A illustrates the voltage profiles of the 20^{th}, 40^{th}, and 110^{th} cycles of Zn//CF flow cells with and without Bi₂O₃. After 20 cycles, the voltage profiles of the cell without Bi₂O₃ exhibit a sharp surge at the end of the charging process, presumably due to the loss of active materials. As the cycle progresses, this surge occurs earlier, indicating that the detrimental effects on the cell continue to accumulate after dead zinc emerges. Nevertheless, the polarization of the voltage distribution of the Zn//CF flow cell with Bi₂O₃ does not deteriorate throughout the cycling process.

FIG. 12B depicts the XRD patterns of the taupe deposits collected from the anolyte tank in the presence of Bi₂O₃. No dead zinc is detected in the anolyte tank. Instead, only large quantities of metallic bismuth are detected due to the discharge of the Zn//Bi₂O₃ battery. Moreover, the elemental maps of taupe deposits reveal the presence of bismuth and oxygen and the absence of zinc. These results indicate that adding enough Bi₂O₃ with rapid reaction kinetics completely regenerates dead zinc even at a high current density and areal capacity.

As shown in FIG. 12C, the Zn//CF flow cell with Bi₂O₃ undergoes over 250 cycles at a high AUR of 99%, and it exhibits a high CE of 99.2% under harsh conditions (80 mA cm⁻² and 79.6 mAh cm⁻²) with a considerably low capacity fading rate of 0.014 mAh cm⁻² per cycle. In addition, the discharge capacity of the cell without Bi₂O₃ continues to decrease with a capacity decay rate of approximately 0.34 mAh cm⁻² per cycle, indicating the formation of dead zinc at a high areal capacity.

### Example 3—Preparation of AZIFBs

An AZIFB is assembled by sandwiching a membrane between two CF electrodes clamped by two graphite plates. The active area of the electrode is 2×2 cm⁻². The PBI membrane is used to separate the catholyte and anolyte. The anolyte contains 0.3 mol L⁻¹ Zn(OH)₄²⁻ and 3.2 mol L⁻¹ OH⁻ or 0.5 mol L⁻¹ Zn(OH)₄²⁻ and 3 mol L⁻¹ OH⁻. The catholyte contains 0.6 mol L⁻¹ Fe(CN)₆⁴⁻ and 3 mol L⁻¹ OH⁻. The different concentration electrolytes are used to flow pass the batteries. The batteries are operated at a constant current density and the charge process is controlled by the capacity of anolyte.

According to the volume of added anolyte, the capacity released when the AUR is 100% can be calculated. Considering the influence of side reactions, etc., the charging process is controlled by a capacity of 99% anolyte utilization rate or a protecting cutoff voltage. The discharge process is ended with a cutoff voltage of 0.1 V. The utilization rate of catholyte is 50%. For the flow batteries with Bi₂O₃, an excess of Bi₂O₃ is added to the anolyte tank, with the initial addition amount being 1 g. To optimize dead zinc recovery, the added Bi₂O₃ is spread flat on the bottom of the tank. When the taupe Bi product is observed spreading over the yellow Bi₂O₃, the mixture of Bi and Bi₂O₃ should be stirred to ensure that the dead zinc is in contact with the Bi₂O₃. During long-cycle battery testing, when a significant amount of taupe product is observed at the bottom of the tank, 1 g of fresh Bi₂O₃ should be added to the tank to maintain a stable supply of Bi₂O₃. All the battery performance tests are conducted by CT3001A, LAND Battery Testing System.

### Example 4—Evaluating the Ability of Bi₂O₃ to Regenerate Exfoliated Dead Zinc

To evaluate the capability of Bi₂O₃ to regenerate exfoliated dead zinc, a Zn//CF flow cell without Bi₂O₃ is tested at a high areal capacity and an AUR of 99%. As shown in FIG. 12D, although the discharge capacity starts to decrease from the 18^{th} cycle, it is instantaneously recovered after adding Bi₂O₃, indicating that the depletion of Zn(OH)₄²⁻ in the anolyte resulted in a decrease in capacity.

Compared to the Zn//CF flow cells with Bi₂O₃ added from the beginning (FIG. 12C), adding Bi₂O₃ after the battery starts to degrade partially restores the capacity, indicating the importance of Bi₂O₃ in mitigating the battery's side reactions. Therefore, cumulative discharge capacity is used to quantify the amount of recovered dead zinc in the Zn//CF flow cell.

As shown in FIG. 13, the amount of recovered dead zinc is calculated as 15.43 Ah after 140 cycles at 80 mA cm⁻² and 79.6 mAh cm⁻². Under these operating conditions, every cumulative discharge capacity of 6.6 Ah in the Zn//CF flow cell produces 1 g of metallic bismuth (the price of bismuth is considerably higher than that of Bi₂O₃, Table 2), which can be subsequently collected and recycled. These results confirm the ultrastable cycling performance of Bi₂O₃-mediated dead zinc oxidation, indicating its great potential in zinc-based full-battery applications.

TABLE 2
The bulk price of chemicals on the market

| Chemical | Molecular weight (g mol⁻¹) | Price (US$ kg⁻¹) |
|---|---|---|
| ZnO | 81.39 | 1.3 |
| NaOH | 40.00 | 0.34 |
| NaCl | 58.44 | 0.13 |
| Bi₂O₃ | 465.96 | 10 |
| Bi | 208.98 | 35 |

### Example 5—Zinc Plating and Stripping Behavior

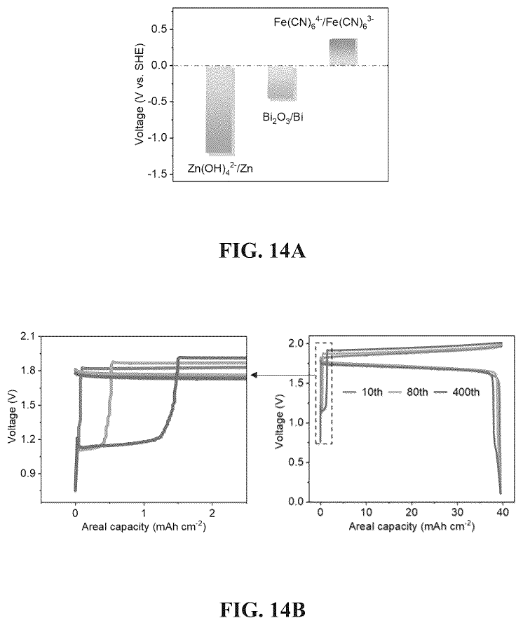

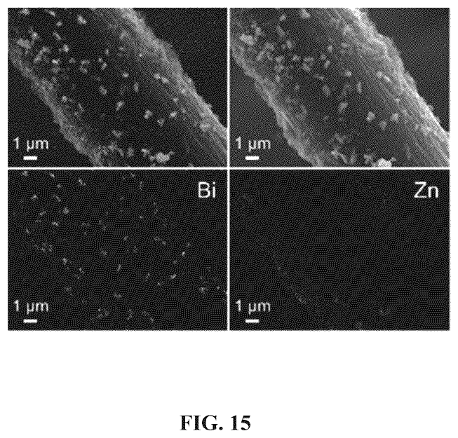

When immersed in the electrolyte, Bi₂O₃ not only regenerates dead zinc but also contributes to reversible zinc plating and stripping due to the in situ formation of Bi and ZnBi alloy interfaces on the electrode from saturated bismuth salts. As shown in FIG. 9, the amount of high-valent Bi* (approximately 1.64×10⁻⁴ mol L⁻¹) in the anolyte remains constant when excess Bi₂O₃ is added. Given that Bi₂O₃/Bi and Zn(OH)₄²⁻/Zn couples have reduction potentials of −0.46 V (vs. standard hydrogen electrode) and −1.22 V (vs. standard hydrogen electrode), respectively, Bi₂O₃ preferentially reacts on the surface of the electrode in the AZIFBs (FIG. 14A). FIG. 14B illustrates the galvanostatic charge-discharge profiles of AZIFBs with Bi₂O₃. As indicated by equation (1), the first low-potential plateau in the charging curve corresponds to the Bi₂O₃/Bi couple. Given the high electrochemical reversibility of the Bi₂O₃/Bi couple, as the cycling process continued, the first plateau becomes more extended, and bismuth-associated deposits accumulate on the electrode.

To elucidate the reaction of the anode in the presence of multi-electronic pairs, anodic CF charged to 1.6 V at the 75^{th} cycle of an AZIFB with Bi₂O₃ is characterized.

FIG. 15 shows images obtained using scanning electron microscopy (SEM) and corresponding elemental maps. The characterization results indicate a homogenous distribution of bismuth metal particles on the CF, with a small amount of underpotentially deposited zinc around the bismuth particles (hereinafter referred to as the Bi@Zn interface).

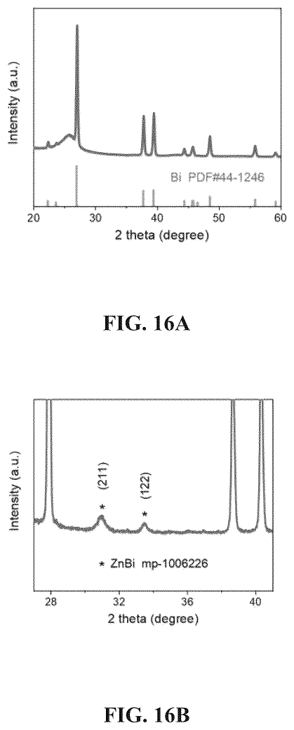

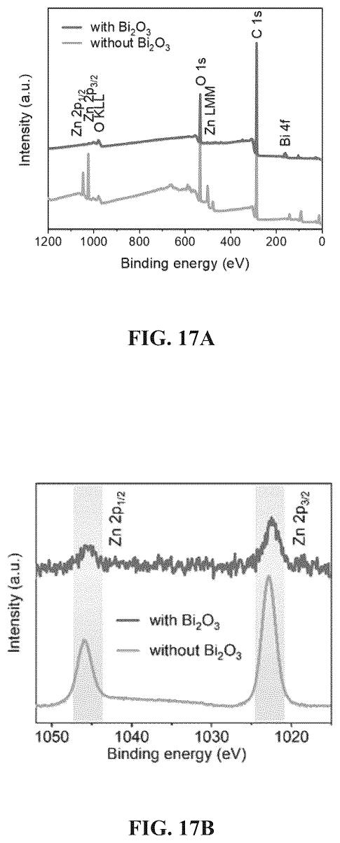

FIG. 16A-16B depict the XRD results of anodic CF charged to 1.6 V in an AZIFB with Bi₂O₃. A distinct peak corresponding to metallic bismuth (JCPDS No. 44-1246) is observed. In addition, two weak characteristic signals are observed at approximately 310 and 33°, corresponding to the characteristic peaks of the ZnBi alloy (mp-1006226) and the (211) and (122) crystal planes, respectively. These results are further supported by X-ray photoelectron spectroscopy (XPS) findings, confirming the similar composition of Zn, C, and O elements in anodic CF obtained from AZIFBs with and without Bi₂O₃ and verifying their surface Zn—O and/or Bi—O bonds (FIG. 17A). FIG. 17B depicts two typical peaks for Zn 2p in the high-resolution XPS spectra of bare Zn and the Bi@Zn interface. Compared with bare Zn, the characteristic peaks of Zn 2p at the Bi@Zn interface shift to a lower binding energy, indicating a decrease in the valence state of zinc due to the formation of a ZnBi alloy. These results confirm that the deposits observed at the initial stage on the CF at the Bi@Zn interface Are primarily Bi and ZnBi alloys.

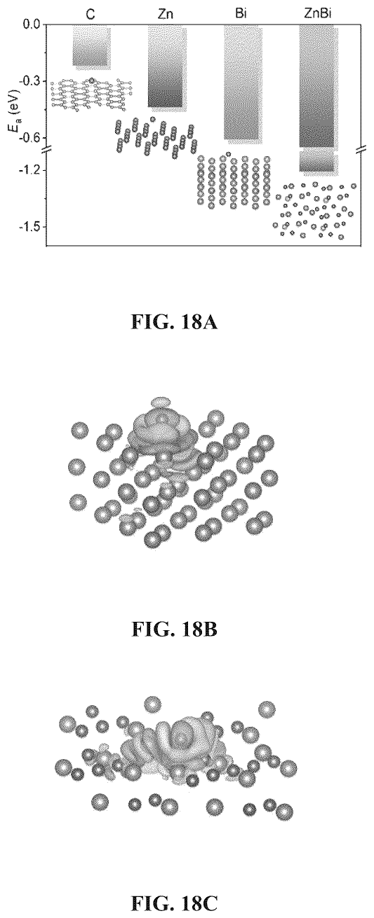

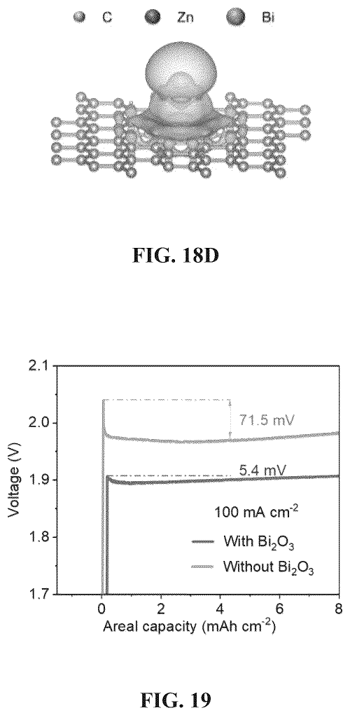

To determine the effect of Bi and ZnBi alloy interfaces on the subsequent zinc plating, Ab-initio calculations are performed. Referring to FIG. 18A, the adsorption energy (Eₐ) values of Zn atoms on carbon (C) and Zn (101) substrates are calculated to be −0.22 and −0.44 eV, respectively, which are substantially higher than those of Bi (012) (−0.61 eV) and ZnBi (211) (−1.21 eV), indicating the strong affinity of Zn for Bi and ZnBi alloy. FIGS. 18B-18D illustrate the differential charge density of Zn atoms adsorbed on the surface of different substrates. The results indicate that the presence of Bi and ZnBi alloy triggers charge transfer and redistribution at the electrode interface, indicating a strong delocalized electronic interaction and polarization between Zn and Bi and ZnBi alloy.

Consequently, the Bi and ZnBi alloy interfaces reduce the zinc nucleation overpotential from 71.5 to 5.4 mV, indicating its low energy barrier for zinc deposition (FIG. 19). These results correlate with the strong bonding interaction between Zn, Bi, and the ZnBi alloy. In summary, the in situ formation of Bi and ZnBi alloy interfaces on CF increases the kinetics of zinc deposition and reduces the inhomogeneous deposition of zinc.

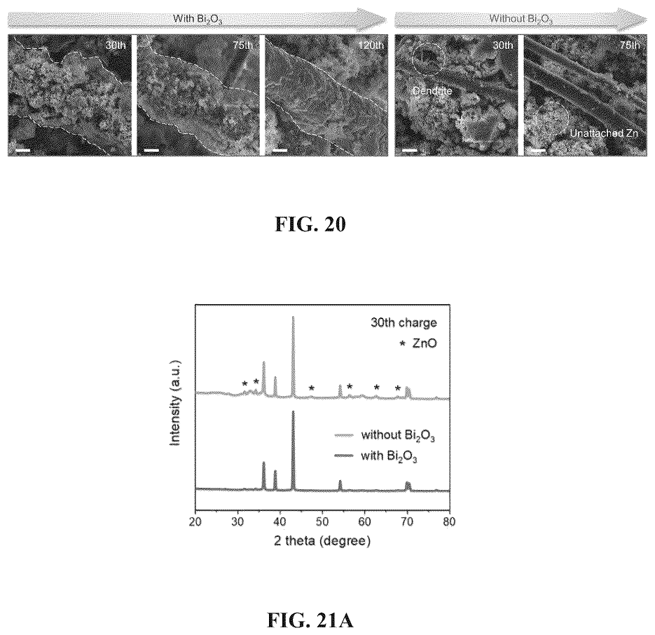

To gain further insight into the effect of the Bi@Zn interface on zinc deposition during the charging process, the morphology of deposited zinc on anodic CF is characterized. As indicated by the SEM images shown in FIG. 20, zinc is uniformly deposited on the fiber of CF after cycling, confirming that the Bi and ZnBi alloy interfaces induce uniform and dense electrochemical zinc deposition. As cycling progressed, the content of Bi and ZnBi alloys on the interface increase, and the induction effect on zinc deposition also increases, resulting in the compact wrapping of deposited zinc on the fiber and thus improving the cycle life of the AZIFB.

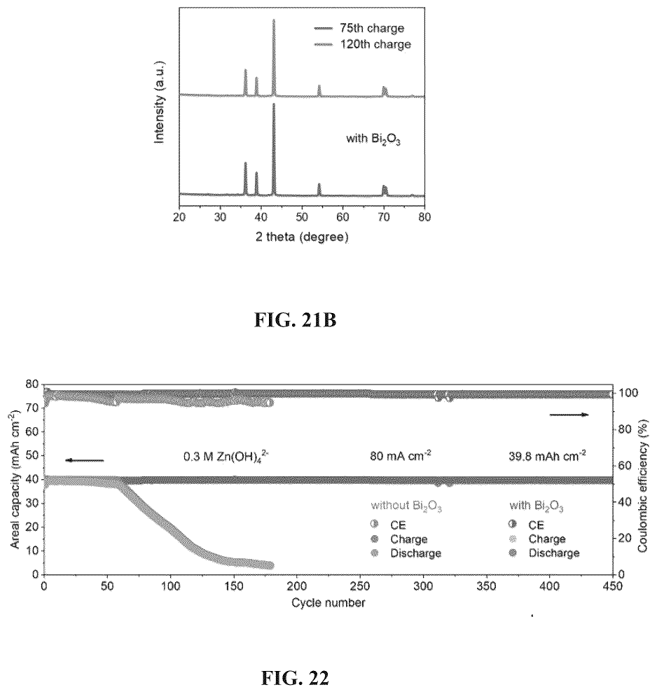

By contrast, scattered and loose zinc particles are observed with large blocks between the fibers in the AZIFB without Bi₂O₃. Most of the fiber surfaces are not covered by deposited zinc, thereby promoting the formation of zinc dendrites and increasing the rate of shedding. As shown in FIGS. 21A-21B, ZnO by-products are detected on zinc deposits in the absence of Bi₂O₃. However, only zinc deposits are detected even after multiple cycles in the presence of Bi₂O₃, indicating that the Bi and ZnBi alloy interfaces regulate the deposition of zinc and stabilize the electrochemical process of the zinc anode.

### Example 6—Electrochemical Performance of AZIFBs

Building on the promising results from half cells and zinc plating and stripping behavior, the Bi₂O₃-mediated oxidation of dead zinc in deep-cycle AZIFBs is further investigated.

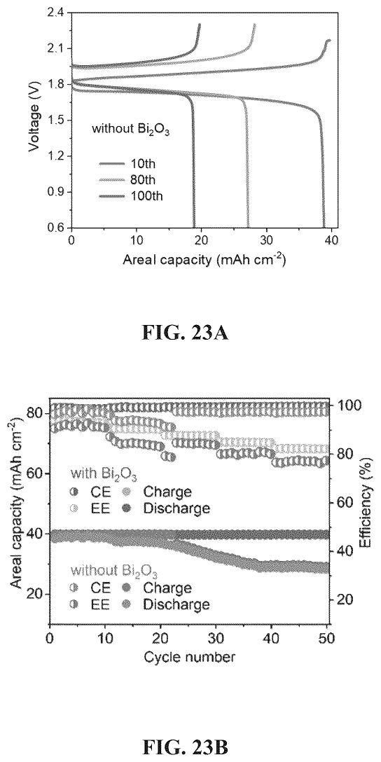

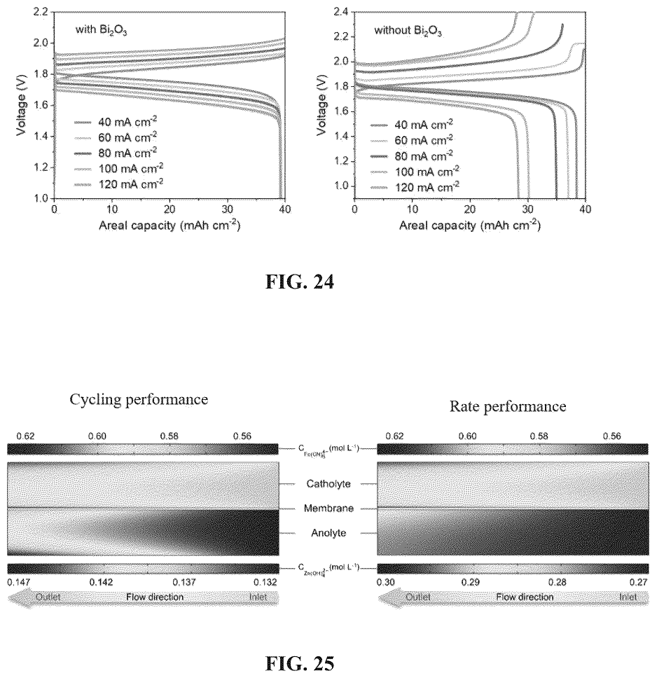

The AZIFBs use a Fe(CN)₆³⁻/Fe(CN)₆⁴⁻ pair as positive active material. As shown in FIG. 22, the AZIFB with Bi₂O₃ achieves an average CE of 99.6% and an ultrahigh AUR of 99% at a high current density of 80 mA cm⁻², and the battery stably undergos over 450 cycles. Evaluating the AZIFB without Bi₂O₃ under the same conditions reveals a rapid decrease in its capacity from the 60^{th} cycle, with a fading rate of 0.29 mAh cm⁻² per cycle, as a result of Zn(OH)₄²⁻ depletion (FIG. 23A). FIG. 23B depicts the rate performance of AZIFBs with and without Bi₂O₃ measured at current densities ranging from 40 to 120 mA cm⁻². As current density increases, the CE of the AZIFB with Bi₂O₃ remains stable at 98.8% to 99.5%, whereas its EE slightly decreases as a result of increased electrochemical and ohmic polarization, yielding an EE of over 82% at a high current density of 120 mA cm⁻². By contrast, the voltage profile of the AZIFB without Bi₂O₃ indicates that the adverse effects of Zn(OH)₄²⁻ deficiency are exacerbated by the increase in current density (FIG. 24), which consequently results in more severe zinc exfoliation, thereby leading to clear fluctuations in CE and EE.

### Example 7—Establishing a Cross-Sectional Model

To elucidate the transport process of active ions within the CF electrode, a straightforward cross-sectional model of AZIFBs is established. A COMSOL Multiphysics simulation is conducted to determine the distribution of Zn(OH)₄²⁻ and Fe(CN)₆⁴⁻ on the negative and cathodes, respectively, of each AZIFB.

FIGS. 25A-25B show the simulation results of ion distribution at the beginning of the 100^{th} charge from the two AZIFBs with and without Bi₂O₃. For the cathode, a consistent Fe(CN)₆⁴⁻ distribution is observed in the two AZIFBs, indicating that Bi₂O₃ does not considerably affect the cathode reaction. During the cycling process, accumulated zinc exfoliation results in the rapid decay of Zn(OH)₄²⁻ concentration in the AZIFB without Bi₂O₃, decreasing from 0.3 mol L⁻¹ in the first cycle to 0.147 mol L⁻¹ in the 100^{th} cycle.

To make matters worse, as the available Zn(OH)₄²⁻ ions continue to decrease, the inhomogeneity of Zn(OH)₄²⁻ ion distribution is greatly aggravated (FIG. 25). These factors lead to uneven zinc plating, resulting in a low-reliability AZIFB with a high AUR. In contrast, the distribution of Zn(OH)₄²⁻ concentration in the electrode is more even, which is attributable to two factors:
(1) Dead zinc underwent rapid regeneration, contributing to an abundant supply of Zn(OH)₄²⁻.
(2) The Bi/ZnBi functional layer on the CF induced current density homogenization and reduced the local current density, thereby reducing zinc dendrites.

In addition to cycling stability, areal capacity is a crucial design parameter in AZIFBs. In ZFBs, increasing the areal capacity of zinc also increases the energy density of the battery, which is particularly suitable for long-term energy storage applications.

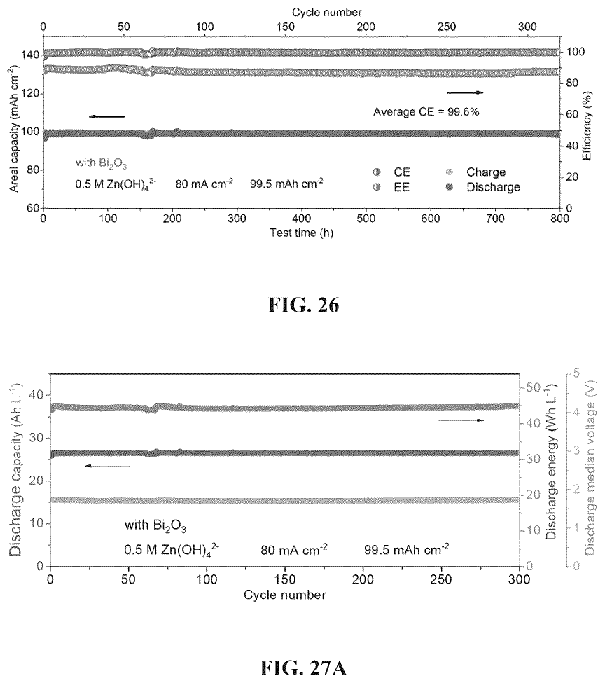

In this invention, to increase the energy density of AZIFBs and evaluate the Bi₂O₃-mediated chemistry of zinc at a high areal capacity, a battery is assembled with Bi₂O₃ at a high concentration of Zn(OH)₄²⁻ (i.e., 0.5 mol L⁻¹). FIG. 26 shows that the battery delivers ultrastable cycling performance for over 800 h and achieves a high average CE and an average EE of 99.6% and 87.2%, respectively, at an AUR of 99%. Benefiting from the high AUR of 99%, even at a high current density of 80 mA cm⁻², the battery provides an average discharge capacity of 26.4 Ah L⁻¹, which is very close to the theoretical capacity (26.8 Ah L⁻¹).

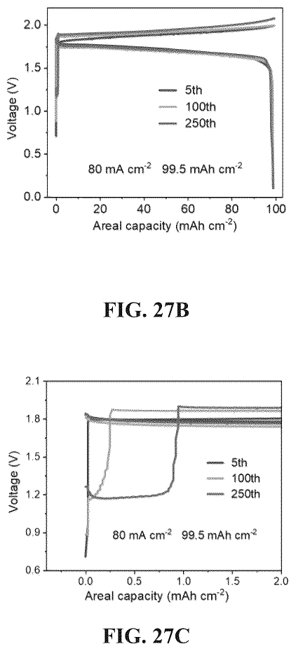

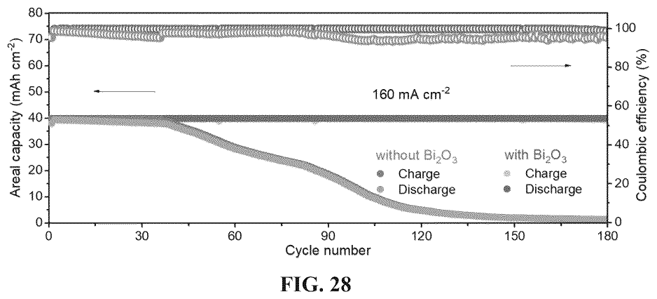

As shown in FIG. 27A, the AZIFB assembled with Bi₂O₃ also delivers an average discharge voltage of 1.7 V, contributing an average energy density of 44.8 Wh L⁻¹. After multiple cycles, voltage profiles with almost identical shapes are observed, confirming the role of the in situ grown Bi/ZnBi on CF in the reduction of battery polarization (FIGS. 27B-27C). Even with deep cycling at a high current density of 160 mA cm⁻², the Bi₂O₃-based AZIFB achieves an ultrahigh AUR of 99% and delivers stable performance for 180 cycles, making the highest AUR ever reported among ZFBs at such a high current density (FIG. 28). Overall, these results collectively confirm the suitability of Bi₂O₃-boosted zinc chemistry for practical ZFB applications.

### Example 8—Quantifying the Recovered Amount of Dead Zinc in AZIFBs with and without Bi₂O₃

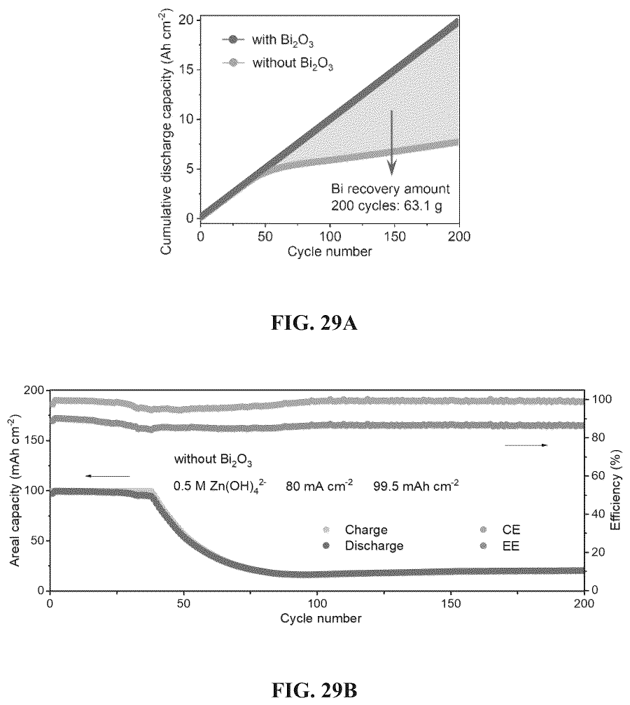

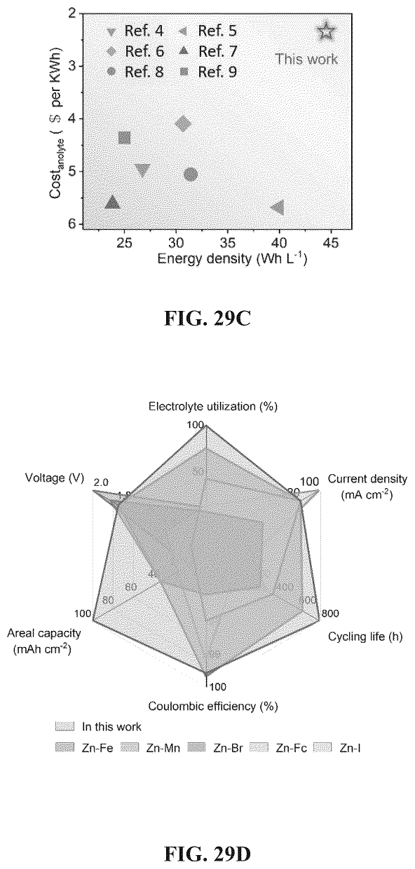

After 200 cycles, the recovered amount of dead zinc is calculated to be 48.56 Ah at 80 mA cm⁻² and 99.5 mAh cm⁻² at a Zn(OH)₄²⁻ concentration of 0.5 mol L⁻¹ (FIGS. 29A-29B). Under the aforementioned operating conditions, 63.1 g of metallic bismuth is produced after 200 cycles, which can be subsequently collected and recycled. In other words, every cumulative discharge capacity of 2.11 Wh in the AZIFB with Bi₂O₃ produces 1 g of metallic bismuth. Generally, Bi₂O₃ is the main constituent of Bi minerals, and the metallic bismuth obtained from the reduction of Bi₂O₃ is regarded as a high-value-added product. Consequently, the metallic bismuth generated in AZIFBs without additional energy consumption can cause economic benefits, further reducing the cost of the battery. Table 3 shows the calculation process of the cost of the AZIFB anolyte.

TABLE 3
The anolyte cost for AZIFBs

| | Anolyte | | | |
|---|---|---|---|---|
| Anolyte | utiliza- | Energy | Anolyte cost | |
| composition | tion | density | (US$ KWh⁻¹) | Note |
| 0.5M Zn(OH)₄²⁻ + | 53.1 | 40.00 | 5.70 | Prior |
| 4M NaOH | | | | art |
| 0.4M Na₂Zn(OH)₄ + | 74.6 | 30.71 | 4.10 | |
| 3M NaOH | | | | |
| 0.4M Zn(OH)₄²⁻ + | 70.8 | 26.78 | 4.96 | |
| 3M NaOH | | | | |
| 0.4M Zn(OH)₄²⁻ + | 70.0 | 23.87 | 5.63 | |
| 3M OH⁻ | | | | |
| 0.5M Zn(OH)₄²⁻ + | 67.4 | 31.45 | 5.07 | |
| 4M NaOH | | | | |
| 0.3M Na₂Zn(OH)₄ + | 70.0 | 25.00 | 4.36 | |
| 2.4M NaOH + 0.5M | | | | |
| NaCl | | | | |
| 0.5M Zn(OH)₄²⁻ + | 99.0 | 44.75 | 2.42 | This |
| 3M OH⁻ | | | | inven- |
| | | | Cost of Bi₂O₃: 5.28 | tion |
| | | | Value of recycled | |
| | | | Bi: 16.57 | |
| | | | Income of Bi: 11.29 | |

In Table 3, the recycling of metallic bismuth can obtain a profit of $11.29/kWh. At the same time, given the advantages of the Bi₂O₃-mediated regeneration of dead zinc, the capital cost of the fully utilized anolyte is reduced to approximately $2.42/kWh, which is considerably lower than the cost of other AZIFBs (FIG. 29C).⁴⁻⁹ By comparing the pivotal performance parameters in the aspect of electrolyte utilization, current density, cycle life, CE, and voltage, the AZIFB with Bi₂O₃ demonstrates a very competitive performance among recently reported ZFBs (FIG. 29D)).

Additionally, over the long cycle, by adding a stirring system at the bottom of the storage tank, the added Bi₂O₃ can be used until the conversion rate exceeds 80%. When 50%, 70% and 80% of the Bi₂O₃ are converted to Bi, there is a noticeable taupe Bi product formed on the surface of the zinc foil upon immersion in the above-mentioned mixture, consistent with the phenomenon when fresh Bi₂O₃ is used. When the conversion rate of Bi₂O₃ rises to 90%, the taupe product on the surface of the zinc foil decreases, indicating that the insufficient Bi₂O₃ content affects the reaction rate with zinc. Therefore, during long-term battery operation, Bi₂O₃ can be used at a conversion rate of approximately 80%, which still has a good effect on regenerating dead zinc.

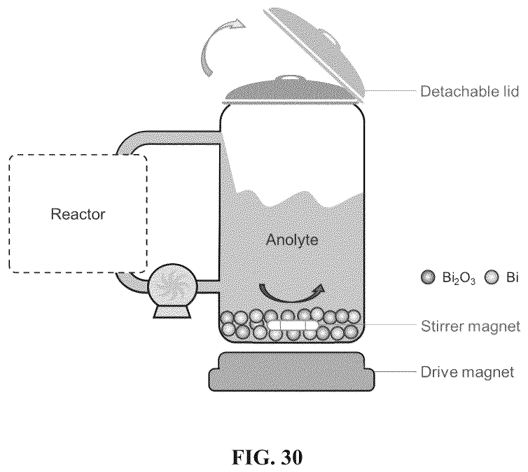

Furthermore, thanks to the separation design of the flow battery's reactor and the electrolyte tank, products with high bismuth content at the bottom of the tank can be regularly removed through the lid and replaced with new Bi₂O₃(FIG. 30). These results indicate that Bi₂03-based AZIFBs are a promising candidate for large-scale stationary and distributed electrochemical energy storage applications.

In summary, the present invention presents an effective strategy for addressing the issue of zinc exfoliation and dendrite formation in zinc-based flow batteries by incorporating Zn—Bi₂O₃ in the anolyte. The addition of Bi₂O₃ facilitates the oxidation of inactive zinc, thereby recovering lost capacity. Moreover, the in situ formation of a functional interface between Bi and ZnBi alloy promotes uniform and dense zinc deposition. This significantly enhances the cycling performance of the zinc anode, especially under high current densities, high areal capacities, and deep-cycle conditions. As a result, an ultrastable AZIFB with Bi₂O₃ is achieved, demonstrating a current density of 80 mA cm⁻², an AUR of 99%, and an average CE of 99.6% over 450 cycles. At an even higher areal capacity of 99.5 mAh cm⁻², the AZIFB maintains an AUR of 99% for over 800 hours, with a discharge energy of 44.8 Wh L⁻¹, significantly reducing the anolyte cost to a record low of $2.42/kWh. Overall, this innovative strategy offers a reliable solution for enhancing the long-term stability and deep-cycle performance of AZIFBs, providing a solid foundation for further progress in zinc-based flow battery technology.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of 10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

The term “electrochemical modifier” refers to a material or compound incorporated into the anolyte to facilitate electrochemical reactions, such as the oxidation of dead zinc formed on the anode, improving the overall performance of the zinc-based flow battery. Example modifiers include metal oxides like bismuth(III) oxide or other conductive or catalytic compounds.

The term “zinc-compatible material” refers to materials that are chemically stable in the presence of zinc and do not degrade or react undesirably when in contact with zinc during cycling in a flow battery.

The term “active material” refers to materials that facilitate the flow of electric current through the cathode in a flow battery. Examples of active materials include metals like iron (Fe), and metal salts like ferrocyanide salts (e.g., Fe(CN)₆⁴⁻) or other conductive compounds or polymers.

The term “supporting electrolyte” refers to an additional electrolyte component in the anolyte or catholyte that enhances the ionic conductivity of the electrolyte solution. It typically consists of strong alkaline salts.

The term “flow system” refers to the arrangement of components, such as pumps, valves, and tubing, that circulates the anolyte and catholyte through the electrochemical cells of a flow battery to enable continuous operation and regeneration of active species.

The term “dead zinc” refers to the zinc that has been irreversibly oxidized or deactivated during the discharge cycle, typically accumulating on the anode, which may reduce the efficiency of the battery unless reactivated by the electrochemical modifier.

The term “ZnBi functional interface” refers to the interface formed between zinc and bismuth, resulting in the creation of a ZnBi alloy during cycling. This interface plays a critical role in regulating zinc deposition and suppressing dendrite growth, contributing to the stable operation of the flow battery.

The term “areal capacity” refers to the capacity of the zinc-based flow battery per unit area of the electrode. It quantifies the amount of charge that can be stored or discharged per unit area of the electrode material.

The term “exfoliated dead zinc” refers to the portion of dead zinc that has detached or flaked off from the anode surface during cycling, typically due to mechanical stresses or oxidation. Exfoliation may negatively impact battery performance unless effectively managed or recycled by the electrochemical modifier.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCES: THE DISCLOSURES OF THE FOLLOWING REFERENCES ARE INCORPORATED BY REFERENCE

1. Wang Y, et al. Manipulating Electric Double Layer Adsorption for Stable Solid-Electrolyte Interphase in 2.3 Ah Zn-Pouch Cells. Angew. Chem. Int. Ed. 135, e202302583 (2023).
2. Liu J, Ye C, Wu H, Jaroniec M, Qiao S Z. 2D Mesoporous Zincophilic Sieve for High-Rate Sulfur-Based Aqueous Zinc Batteries. J. Am. Chem. Soc. 145, 5384-5392 (2023).
3. Liang G, et al. Regulating Inorganic and Organic Components to Build Amorphous-ZnF(x) Enriched Solid-Electrolyte Interphase for Highly Reversible Zn Metal Chemistry. Adv. Mater. 35, e2210051 (2023).
4. Yuan Z, Liu X, Xu W, Duan Y, Zhang H, Li X. Negatively charged nanoporous membrane for a dendrite-free alkaline zinc-based flow battery with long cycle life. Nat. Commun. 9, 3731 (2018).
5. Yuan Z, Duan Y, Liu T, Zhang H, Li X. Toward a Low-Cost Alkaline Zinc-Iron Flow Battery with a Polybenzimidazole Custom Membrane for Stationary Energy Storage. iScience 3, 40-49 (2018).
6. Yuan Z, et al. Low-cost hydrocarbon membrane enables commercial-scale flow batteries for long-duration energy storage. Joule 6, 884-905 (2022).
7. Hu J, et al. Layered double hydroxide membrane with high hydroxide conductivity and ion selectivity for energy storage device. Nat. Commun. 12, 3409 (2021).
8. Chen Z, et al. Mathematical modeling and numerical analysis of alkaline zinc-iron flow batteries for energy storage applications. Chem. Eng. J. 405, 126684 (2021).
9. Gong K, et al. A zinc-iron redox-flow battery under $100 per kW h of system capital cost. Energy Environ. Sci. 8, 2941-2945 (2015).

1. A high-performance, durable, and self-regenerating zinc-based flow battery, comprising:
an anolyte containing zinc salts and an electrochemical modifier;
a catholyte containing ferrocyanide salts;
a membrane separating the anolyte and the catholyte,
an anode comprising a zinc-compatible material;
a cathode comprising an active material;
a flow system configured to circulate the anolyte and the catholyte; and
a power management system operably connected to the anode and the cathode,
wherein the electrochemical modifier facilitates an electrochemical oxidation of dead zinc formed on the anode, enhancing an anolyte utilization rate to at least 99% at an even higher areal capacity of at least 100 mAh cm⁻² for over 800 hours, and promoting uniform and dense zinc deposition during cycling, and
wherein the electrochemical modifier has a concentration sufficient to sustain oxidation of the dead zinc for at least 200 cycles.

2. The high-performance, durable, and self-regenerating zinc-based flow battery of claim 1, wherein the anolyte further comprises Zn(OH)₄²⁻ and a supporting electrolyte selected from KOH and NaOH, wherein the concentration of Zn(OH)₄²⁻ in the anolyte is between 0.3 and 0.5 mol L⁻¹, and the concentration of the supporting electrolyte is between 1 to 5 mol L⁻¹.

3. The high-performance, durable, and self-regenerating zinc-based flow battery of claim 2, wherein during charging, the Zn(OH)₄²⁻ undergoes reduction to deposit Zn on the anode, and the active material undergoes an oxidation reaction on the cathode.

4. The high-performance, durable, and self-regenerating zinc-based flow battery of claim 3, wherein the catholyte includes active materials one or more of Na₄Fe(CN)₆, K₄Fe(CN)₆, Na₃Fe(CN)₆, K₃Fe(CN)₆, with a concentration of 0.1 to 1.6 mol L⁻¹.

5. The high-performance, durable, and self-regenerating zinc-based flow battery of claim 2, wherein during discharge, oxidated active material undergoes a reduction reaction, and the Zn on the anode undergoes an oxidation reaction to form the Zn(OH)₄²⁻.

6. The high-performance, durable, and self-regenerating zinc-based flow battery of claim 1, wherein the zinc salts comprises one or more of ZnO, Zn(CH₃COO)₂, ZnBr₂, ZnCl₂, ZnSO₄, with a concentration of 0.1 to 2 mol L⁻¹.

7. The high-performance, durable, and self-regenerating zinc-based flow battery of claim 1, wherein the electrochemical modifier comprises bismuth(III) oxide, indium oxide (In₂O₃), or a combination thereof.

8. The high-performance, durable, and self-regenerating zinc-based flow battery of claim 1, wherein the catholyte further comprises a supporting salt comprising one or more of, KOH, NaOH, with a concentration of 0.1 to 5 mol L⁻¹.

9. The high-performance, durable, and self-regenerating zinc-based flow battery of claim 1, wherein the membrane comprises a porous membrane or an ion exchange membrane.

10. The high-performance, durable, and self-regenerating zinc-based flow battery of claim 1, wherein the zinc-compatible material comprises carbon felt or a zinc plate.

11. The high-performance, durable, and self-regenerating zinc-based flow battery of claim 1, wherein the zinc-based flow battery further comprises a graphite plate configured to support the anode and cathode structures.

12. The high-performance, durable, and self-regenerating zinc-based flow battery of claim 1, wherein the electrochemical oxidation of the dead zinc allows for recovery of at least 90% of exfoliated dead zinc.

13. The high-performance, durable, and self-regenerating zinc-based flow battery of claim 1, wherein the zinc-based flow battery is configured to operate at a current density of 80 mA cm⁻² and achieves an anolyte utilization rate of at least 99%, delivering an average coulombic efficiency of at least 99% over more than 450 cycles.

14. The high-performance, durable, and self-regenerating zinc-based flow battery of claim 1, wherein the zinc-based flow battery maintains an average energy efficiency of at least 85% over 300 cycles.

15. The high-performance, durable, and self-regenerating zinc-based flow battery of claim 1, wherein a functional interface comprising bismuth and ZnBi alloy is formed during cycling.

16. A method for reducing zinc dendrite growth and dead zinc accumulation in a zinc-based flow battery, comprising:
providing an anolyte containing Zn(OH)₄²⁻ at a concentration of 0.3 to 0.5 mol L⁻¹ and an electrochemical modifier;
operating the zinc-based flow battery by cycling between charging and discharging states;
oxidizing dead zinc in the anolyte via electrochemical oxidation facilitated by the electrochemical modifier to regenerate active zinc species; and
forming a functional interface comprising bismuth and ZnBi alloy interface to regulate zinc deposition and suppress dendrite growth,
wherein the zinc-based flow battery is operated at a current density of at least 80 mA cm⁻², and
wherein the zinc-based flow battery achieves an areal capacity of at least 100 mAh cm⁻² while maintaining an anolyte utilization rate of at least 99% for over 800 hours.

17. The method of claim 16, further comprising stirring the electrochemical modifier in the anolyte to ensure contact with exfoliated dead zinc.

18. The method of claim 16, wherein the electrochemical modifier has a concentration sufficient to sustain oxidation of the dead zinc for at least 200 cycles.

19. The method of claim 16, further comprising collecting and recycling metallic bismuth formed during the oxidation of dead zinc.

20. The method of claim 16, wherein the electrochemical modifier comprises bismuth(III) oxide, indium oxide (In₂O₃), or a combination thereof.
